(19) United States
(12) Patent Application Publication
(10) Pub. No.: US 2025/0027586 A1
(43) Pub. Date: Jan. 23, 2025

(54) MODULAR SEALED CONDUIT JOINING SYSTEMS AND METHODS

(71) Applicant: William James Scott, Mesa, AZ (US)

(72) Inventor: William James Scott, Mesa, AZ (US)

(21) Appl. No.: 18/446,426

(22) Filed: Aug. 8, 2023

Related U.S. Application Data
(63) Continuation-in-part of application No. 18/353,716, filed on Jul. 17, 2023.

(51) Int. Cl. F16L 19/02; F16L 15/04; F16L 19/06

(52) U.S. Cl. CPC F16L 19/0212; F16L 15/04; F16L 19/061

(57) ABSTRACT

Systems and methods of the inventive subject matter are directed to components that are used to form lengths of conduit. Such a system can include a male component and a female component, where the male component has a male conical tapered surface on a threaded end and the female component comprises a female conical tapered surface on a threaded end. A B nut can be slid over the male component so a sleeve can be screwed onto the threaded end of the male component, and the B nut can then screw onto the threaded end of the female component, thereby pulling on the sleeve to bring the male component and the female component toward each other. Systems of the inventive subject matter are made from non-metal materials such as machinable ceramics, plastics, polymers, and the like.

This application is a continuation-in-part of and claims priority to U.S. patent application Ser. No. 18/353,716 filed Jul. 17, 2023. All extrinsic materials identified herein are incorporated by reference in their entirety.

### FIELD OF THE INVENTION

The field of the invention is high pressure glass-ceramic conduit systems.

### BACKGROUND

The background description includes information that may be useful in understanding the present invention. It is not an admission that any of the information provided in this application is prior art or relevant to the presently claimed invention, or that any publication specifically or implicitly referenced is prior art.

Conduit is needed in all kinds of different systems. In some situations, conduit can be used to carry gas from one location to another under varying pressures—some extremely high, some low. In some embodiments, even a vacuum can be needed. Currently, conduit systems designed for extreme conditions like high pressure are made from various metals, including steel 316. But in some environments, with certain applications, or with certain gases, steel is not suitable. For example, corrosive gases can damage steel conduit, leading to failure, running electrical wiring through conductive conduit can result in short circuiting or other electrical issues, and in environments like space, on aircraft, surrounded by corrosive gases or liquids, and so on, every component must be optimized to prevent failure.

To withstand extreme environmental conditions and to be capable of use in a wide variety of different applications, materials other than, e.g., steel should be used. But non-metallic materials give rise to new challenges. For example, ceramics are too hard and often too porous to be joined in a way that creates a high-pressure seal. And other non-metal materials can suffer from similar shortcomings. Thus, there exists a need in the art for conduit joining systems that are compatible with non-metal materials and capable of creating gas-sealed conduit in extreme environmental conditions.

These and all other extrinsic materials discussed in this application are incorporated by reference in their entirety. Where a definition or use of a term in an incorporated reference is inconsistent or contrary to the definition of that term provided in this application, the definition of that term provided in this application applies and the definition of that term in the reference does not apply.

### SUMMARY OF THE INVENTION

The present invention provides apparatuses, systems, and methods directed to joining parts together to create modular lengths of conduit that are made using non-metal materials. In one aspect of the inventive subject matter, a conduit joining system is contemplated, comprising: a male component comprising a machinable ceramic; a female component comprising the machinable ceramic; a B nut comprising the machinable ceramic; a sleeve configured to screw onto a threaded portion of the male component, the sleeve comprising the machinable ceramic; the B nut configured to slide over the male component; the sleeve configured to screw onto the male component; and the B nut configured to screw onto the female component such that a portion of the B nut interacts with the sleeve to pull the male component and the female components together.

In some embodiments, the female component comprises a female tapered surface that is complementary to a male tapered surface. The system can also include a seal having an annular shape and comprising a tapered surface that is sized and dimensioned to rest between the male tapered surface and the female tapered surface. Compressing the seal between the male component and the female component results in a gas-tight and fluid-tight seal. In some embodiments, the machinable ceramic is electrically insulating and corrosion resistant.

In another aspect, a conduit joining system is contemplated, comprising: a male component made from a machinable ceramic, the male component comprising a first externally threaded end having a male conical tapered surface; a female component made from the machinable ceramic, the female component comprising a second externally threaded end having a female conical tapered surface; a B nut made from the machinable ceramic, the B nut comprising interior threads configured to mate with the second externally threaded end of the female component; a sleeve made from the machinable ceramic and configured to screw onto a threaded portion of the male component; the B nut configured to slide over the male component such that the sleeve can screw onto the male component, thereby capturing the B nut; and where a portion of the B nut is configured to interact with the sleeve to pull the male conical tapered surface and the female conical tapered surface together upon screwing the B nut onto the female component.

In some embodiments, the system also includes a seal having an annular shape and comprising a tapered surface that is sized and dimensioned to rest between the male conical tapered surface and the female conical tapered surface. Compressing the seal results in a gas-tight and fluid-tight seal. The machinable ceramic can be electrically insulating and corrosion resistant. The female conical tapered surface can be complementary to the male conical tapered surface.

In another aspect, a conduit joining system comprises: a male component; a female component; a B nut; a sleeve configured to screw onto a threaded portion of the male component; the B nut configured to slide over the male component; the sleeve configured to screw onto the male component upon sliding the B nut over the male component; the B nut configured to screw onto the female component such that a portion of the B nut interacts with the sleeve to pull the male component and the female components together; and where each of the male component, the female component, the sleeve, and the B nut are made from a non-metal.

In some embodiments, the B nut is configured to screw onto the female component such that a portion of the B nut interacts with the sleeve to pull the male component and the female components. In some embodiments, the non-metal comprises a machinable ceramic, and in some embodiments the non-metal can be a plastic or a polymer.

One should appreciate that the disclosed subject matter provides many advantageous technical effects including the ability to create modular lengths of conduit from non-metal materials like machinable ceramics while still creating gas-and fluid-tight seals between components.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 shows a section of conduit joined together by a system of the inventive subject matter.

FIG. 2 shows a size view of the system shown in FIG. 1.

FIG. 3 shows a side cutaway view of the assembled system of FIG. 1.

FIG. 4 shows another example of a system of the inventive subject matter implemented with an angled joint.

FIG. 5 shows how systems of the inventive subject matter can be used with multiple parts to create a longer section of conduit.

FIG. 6 shows parts joined by systems of the inventive subject matter to create fixed angles, where the conduit formed by the joined parts feature gentler curves than the bend in the angled joint would suggest.

FIG. 7 shows how tubing can be connected to conduit created by parts joined by systems of the inventive subject matter.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used in the description in this application and throughout the claims that follow, the meaning of “a,” “an,” and “the” includes plural reference unless the context clearly dictates otherwise. Also, as used in the description in this application, the meaning of “in” includes “in” and “on” unless the context clearly dictates otherwise.

Also, as used in this application, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements. Moreover, and unless the context dictates the contrary, all ranges set forth in this application should be interpreted as being inclusive of their endpoints and open-ended ranges should be interpreted to include only commercially practical values. Similarly, all lists of values should be considered as inclusive of intermediate values unless the context indicates the contrary.

Systems of the inventive subject matter are configured to couple different components together to create internal conduits therebetween. Conduit created by such systems can be both fluid and gas-sealed. Systems include a male component that is coupled to a female component with a metal seal therebetween to create a flare fitting that is inverted from the specifications set forth in, e.g., SAE J512, J513 and J514 standards. All components of systems of the inventive subject matter can be made from, e.g., machinable glass-ceramics or other noncorroding materials as described in this application. Systems of the inventive subject matter can be implemented into a wide variety of different parts and components to create high-pressure fluid and gas couplings with superior thermal and conductive capabilities. Systems of the inventive subject matter can create conduit that is protected from high external temperatures or that maintain low internal temperatures, depending on the application. These systems can be used to form lengths of conduit between the different joined components.

Systems of the inventive subject matter have potential in various fields, particularly in defense applications against high-energy lasers in military satellites. Material properties of, e.g., machinable glass-ceramics like Macor are highly suitable for use in environments exposed to radiation, RF, corrosion, high heat, and geothermal conditions.

Ordinarily, glass-ceramic surfaces (and other materials described in this application) cannot create a seal when pressed together, but by using an angled, annular seal between the tapered surfaces of male and female components to be joined together, a high-pressure (e.g., gas tight) seal can be created between the two components. Glass-ceramic materials are corrosion resistant, making alternative materials like steel (e.g., 316 stainless steel) unsuitable.

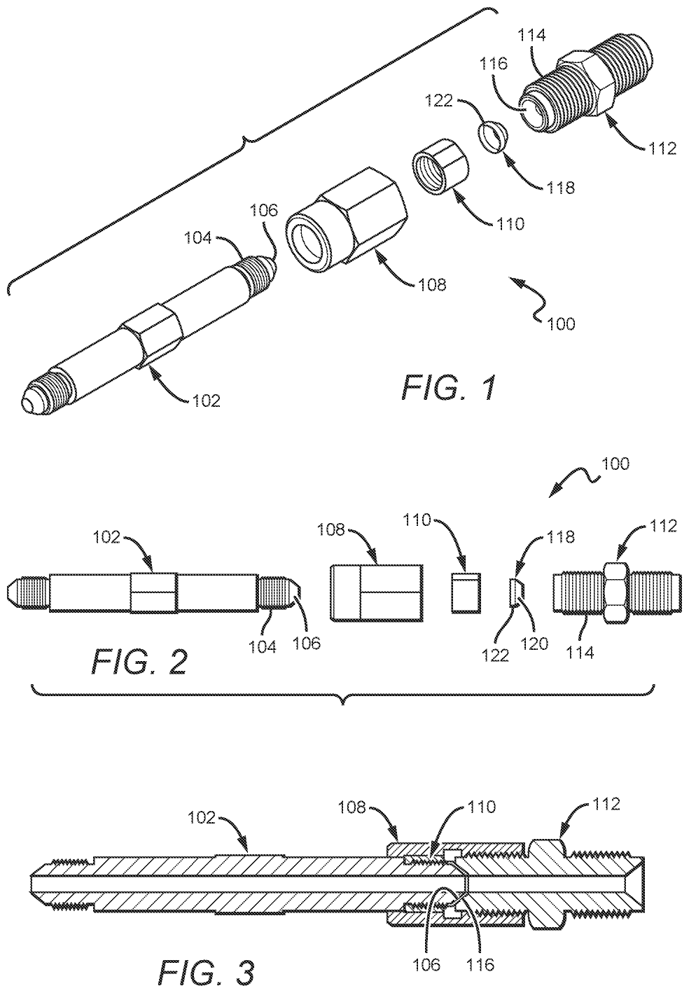

FIG. 1 shows an exploded section of conduit that is can be joined together by a conduit joining system 100 of the inventive subject matter. In some embodiments, the parts in the system are made from glass-ceramic materials and capable of withstanding high internal pressures and low external pressures. For example, systems of the inventive subject matter can be made from machinable glass-ceramics such as, e.g., Macor. Macor has several advantageous material properties. For example, Macor: can be soldered—both to itself and to a wide range of materials; is a mica glass glass-ceramic material; is a versatile glass-ceramic material with technical strength and insulation properties exceeding high performance plastics; is easily machinable using conventional metalworking tools; has fast turnaround times, needing no post firing; holds tight tolerances, up to 0.0005″; is clean, is free of outgassing and has zero porosity; will not deform, unlike ductile materials; has low thermal conductivity, and is an excellent electrical insulator; and is radiation resistant.

Macor can have a density of 2.52 g/cm³, a Young's modulus of 66.9 GPa at 25° C., a specific stiffness of 26.55×106 m2s−2, a Poisson's Ratio of 0.29 and a thermal conductivity of 1.46 W/(m·K). It has a low-temperature (25 to 300° C.) thermal expansion of 9.3×10−6 K−1. Its compressive strength is 50×103 lb/in2 (˜350 MPa). Nominal engineering properties are comparable to borosilicate glass. Other machinable ceramic materials having roughly similar material properties (i.e., within 10% of the listed material properties) can be substituted for Macor without deviating from the inventive subject matter. These other materials can have different material properties from Macor, though some features of Macor should exist in alternative materials as well, such as having low thermal conductivity, being non-deformable, being electrically insulating, and so on, are all beneficial properties. For example, boron nitride can be implemented in some embodiments. COMBAT brand boron nitride, for example, offers exceptional thermal conductivity and lubricity. Vespel materials, such as SP-1, SP-21, SP-3, SP-211, and SP-22, can all be used, as they provide high temperature resistance and low wear rates.

Other non-metal, non-ceramic materials can be implemented as well. For example, polymers like ABS can be used to make components of the inventive subject matter. ABS provides a lightweight and cost-effective solution. Acetal can also be used.

Acetal offers high strength, low friction, and excellent dimensional stability. Acrylic can also be used. Acrylic is known for its optical clarity and weather resistance, providing a durable option. High Density Polyethylene (HDPE) is resistant to chemicals, corrosion, and impact, making it suitable for demanding environments. PEEK (polyetheretherketone) offers high temperature resistance and excellent mechanical properties, and it can be ideal for certain extreme conditions. UHMW (ultra-high molecular weight polyethylene) offers exceptional abrasion resistance, low friction, and self-lubricating properties. Ultem (a polyetherimide) provides excellent thermal stability and chemical resistance. All of these materials can be used in place of, e.g., 316 steel.

In some embodiments, plastics can be used. Some examples include fiberglass such as G-11 glass epoxy laminate and FR5 glass-cloth reinforced epoxy, which offer high strength and electrical insulation. Fluorosint can also be used. Fluorosint materials, such as Fluorosint 500, 207, HPV, 135, and MT-01, provide superior chemical resistance and low friction. FM4910-approved materials, including Kynar 740 and ECTFE (Halar) can be implemented. FM4910-approved materials ensure compliance with strict fire safety regulations. In some embodiments, Nylon can be used, as Nylon 66, 612, ST801, GS, and SLG-FDA PA6, offer excellent wear resistance and toughness. PET-P (Ertalyte) can be used in some embodiments, as it provides dimensional stability and low moisture absorption. Phenolic materials can be used, as well, such as linen phenolic grade LE and canvas phenolic rods, which offer excellent electrical insulation properties. Polyurethane sheets, rods, and tubes (PLUR) can be used, as they provide abrasion resistance and load-bearing capabilities.

FIG. 1 shows an isometric, exploded view of a system of the inventive subject matter incorporated a particular embodiment. The system include a male component 102 having a threaded end 104, where threaded end 104 further comprises a male tapered surface 106. Male tapered surface 106 is configured conically to accommodate seal 118 (acting as, e.g., a gasket). Male tapered surface 106 is formed as a male component such that it can mate with a complementary female component, discussed below. A B nut 108 is also included, whereby B nut 108 comprises a cylindrical body having, on its exterior surface, a smooth end and a wrench end comprising a set of flat surfaces organized to form a hexagon to enable use of wrenches to turn B nut 108. The cylindrical body has a through hole running along its cylindrical axis. Modular systems of the inventive subject matter also include a sleeve 110, which, when used in association with male component 102 and B nut 108, pulls male component 102 toward another component having a conically shaped female surface. Sleeve 110 features interior threads to facilitate coupling with threaded end 104 of male component 102

Female component 112 thus includes a threaded end 114 along with a female tapered surface 116. Female tapered surface 116 is formed conically and complementary to male tapered surface 106. Thus, the apex angle of female tapered surface 116 is the same as the apex angle of male tapered surface 106. The apex angles of the female tapered surface 116 and the male tapered surface 106 also matches the apex angle of seal 118. Seal 118 comprises a tapered surface 120 with cylindrically oriented sidewalls 122 extending therefrom. By placing seal 118 between female tapered surface 116 and male tapered surface 106, seal 118 ensures the system creates an air-tight, high pressure seal between male component

FIG. 2 shows a size view of the system shown in FIG. 1. This perspective makes the angles of male tapered surface 106 and tapered surface 120 of seal 118 more easily visible, and also shows how components are axially aligned.

FIG. 3 shows a side cutaway view of the assembled system. From this view, male component 102 has sleeve 110—which features interior threading—screwed onto its threaded end 104. By screwing sleeve 110 onto threaded end 104, the outer diameter of male component 102 is functionally increased, giving B nut 108 an edge to pull against when it is screwed onto female component 112. In doing so, male component 102 is pulled toward female component 112 (and vice versa), thereby sandwiching seal 118 (which is not indicated in this figure as it is too thin to point to in this view despite its presence) between male tapered surface 106 and female tapered surface 116. When B nut 108 is tightened sufficiently, seal 118 is compressed and deformed, which creates an air-tight, pressure resistant connection between the conduit portions of male component 102 and of the female component 112. These conduit portions are visible in FIG. 3 and are drawn as a continuous conduit that runs the length of the parts in the system.

B nut 108 is configured to improve modularity and ease of use of the system. By having the internal diameters of all portions of B nut 108 greater than the external diameters of the end of male component 102 that B nut 108 mates with, B nut 108 can slide freely along male component 102. As shown in FIG. 3, B nut 108 comprises a lip on the inner left side (as drawn) that has a smaller inner diameter than the rest of B nut 108. By sliding B nut 108 past threaded end 104, threaded end 104 can be exposed while B nut 108 rests around a cylindrical portion of male component beyond threaded end 104. With threaded end 104 exposed, sleeve 110 can be screwed onto threaded end 104. Once sleeve 110 is screwed onto threaded end 104, threaded end 104 functionally takes on a larger outer diameter than male component 102. The new outer diameter of male component 102 with attached sleeve 110 is greater than the smaller inner diameter of the lip of B nut 108. Thus, B nut 108 is captured by attaching sleeve 110 to threaded end 104, and once captured, B nut 108 can be slide over sleeve 110 so that the interior threads of B nut 108 can be mated to threaded end 114 of female component 112. By tightening B nut 108 onto female component 112, the lip of B nut 108 pulls on sleeve 110, which in turn pulls male component 102 toward female component 112 and vice versa.

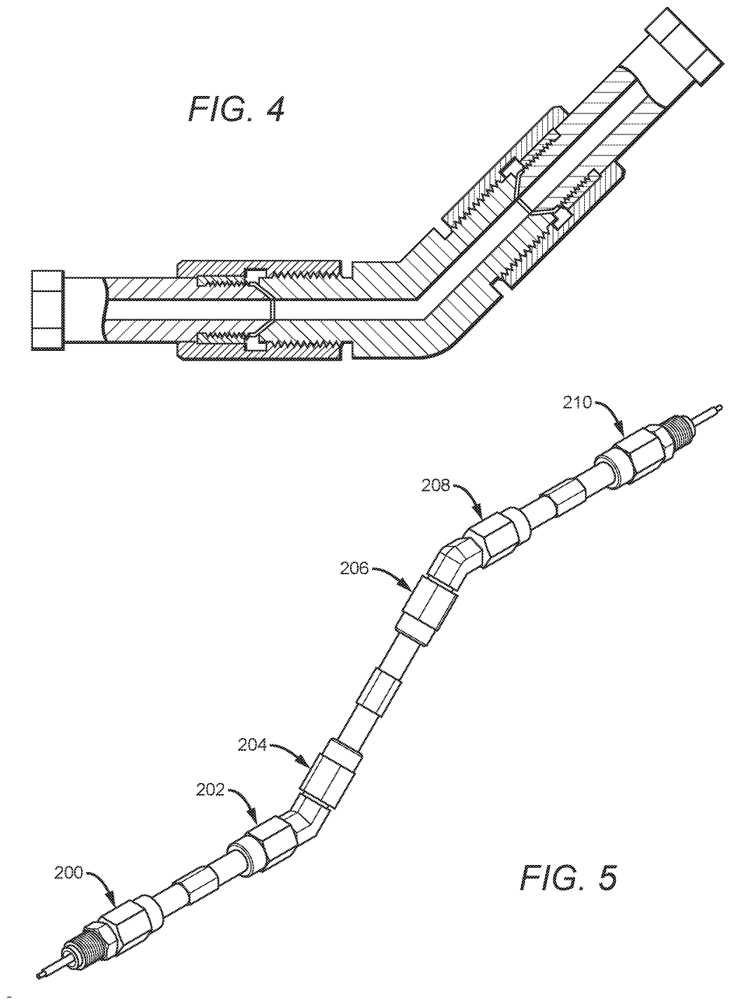

FIG. 4 shows another example of a system of the inventive subject matter implemented with an angled joint. Angled joints can be used to create internal pathways that change directions at a desired angle (e.g., between 1 and 90 degrees, though preferably 15 or 30 degrees). Systems of the inventive subject matter as implemented into an angled joint as shown work identically as described above, whereby each implementation includes a male component, a female component, a sleeve, and a nut. An internal pathway created by an angled joint can be used to string, e.g., electrical wiring from one location to another such that the wiring is insulated from environmental factors and surrounded by a non-conducting material.

FIG. 5 shows how systems of the inventive subject matter can be used with multiple parts to create a longer section of conduit. In this image, six joints are implemented in total. First 200, second 202, third 204, fourth 206, fifth 208, and sixth 210 joining systems are used to join different types of components, demonstrating how systems of the inventive subject matter can be used to create modular lengths of conduit or tubing. FIG. 5 also demonstrates how multiple angled joints can be connected together via systems of the inventive subject matter to create lengths of conduit or tubing that curve or bend around greater angles from its starting direction.

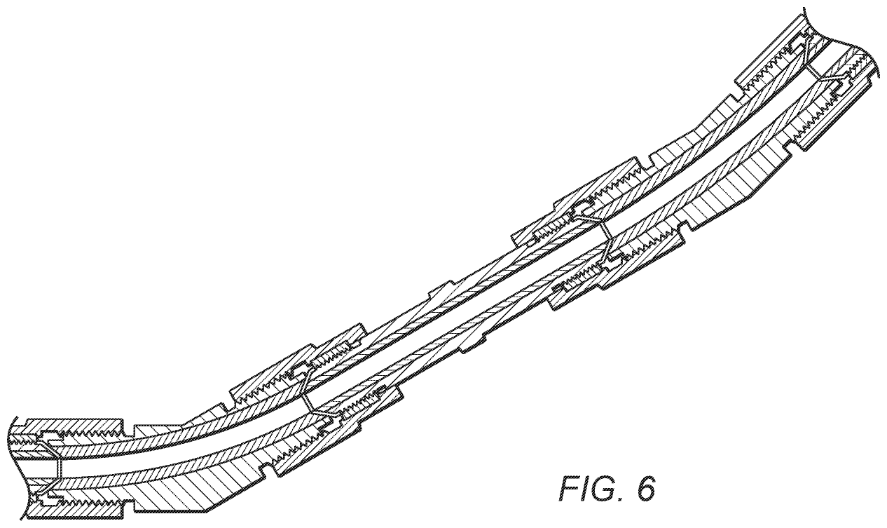

FIG. 6 shows parts joined by systems of the inventive subject matter to create fixed angles, where the conduit formed by the joined parts feature gentler curves than the bend in the angled joint would suggest (e.g., gentler than the bend shown in FIG. 4). More gently curved conduit can accommodate gases or liquids whose flow rates may be impacted by more abrupt angle changes. This is especially advantageous in implementations where gas or fluid flow rate is important for proper functioning of the overall system the conduit is used in.

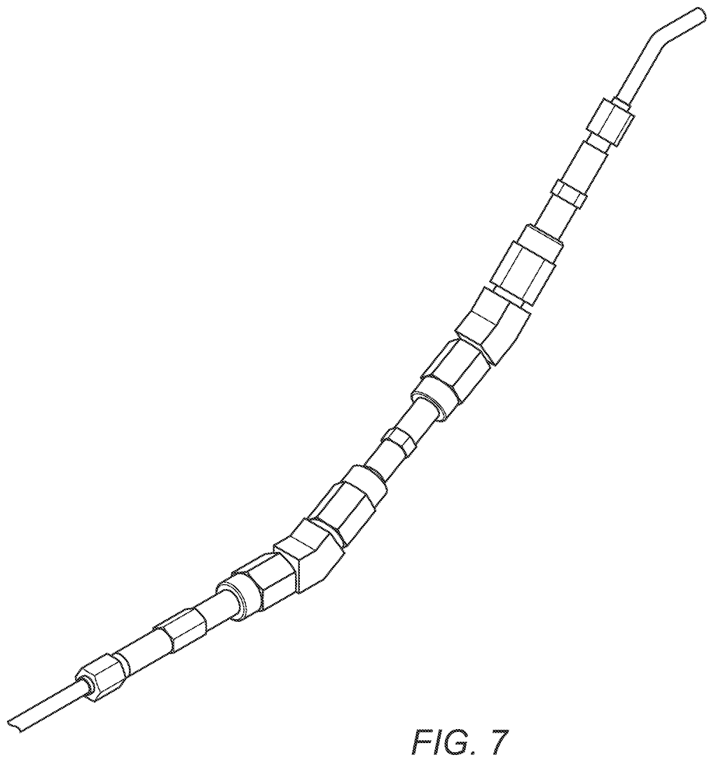

FIG. 7 shows how tubing can be connected to conduit created by parts joined by systems of the inventive subject matter. This demonstrates that conduit created using systems of the inventive subject matter can be part of a hybrid system that comprises metal tubing along with the conduit. Conduit created using systems of the inventive subject matter has several advantages over ordinary metal tubing (e.g., copper tubing), which are emergent from the machinable glass-ceramics used to make the parts.

In some embodiments, tubing can be inserted through a length of conduit created using a conduit joining system of the inventive subject matter. Tubing (such as copper tubing) can be pushed through conduit, causing it to deform and bend as it is pushed through the conduit. For this reason, angled joints can feature 15 or 30-degree angles. These angles allow for 90 degree angles to be achieved.

In some embodiments, systems of the inventive subject matter allow for the insertion of, e.g., a 316 flared tube, with the glass-ceramic components serving as either an insulator or conduit. This enables the integration of, e.g., fiber optic and electrical lines through the formed conduit, providing thermal insulation and increased corrosion resistance.

Thus, specific systems and methods of creating conduit using modular joining components have been disclosed. It should be apparent, however, to those skilled in the art that many more modifications besides those already described are possible without departing from the inventive concepts in this application. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. A conduit joining system, comprising:
a male component comprising a machinable ceramic;
a female component comprising the machinable ceramic;
a B nut comprising the machinable ceramic;
a sleeve configured to screw onto a threaded portion of the male component, the sleeve comprising the machinable ceramic;
the B nut configured to slide over the male component;
the sleeve configured to screw onto the male component; and
the B nut configured to screw onto the female component such that a portion of the B nut interacts with the sleeve to pull the male component and the female components together.

2. The conduit joining system of claim 1, wherein the female component comprises a female tapered surface that is complementary to a male tapered surface.

3. The conduit joining system of claim 2, further comprising a seal having an annular shape and comprising a tapered surface that is sized and dimensioned to rest between the male tapered surface and the female tapered surface.

4. The conduit joining system of claim 2, wherein compressing the seal between the male component and the female component results in a gas-tight and fluid-tight seal.

5. The conduit joining system of claim 1, wherein the machinable ceramic is electrically insulating and corrosion resistant.

6. A conduit joining system, comprising:
a male component made from a machinable ceramic, the male component comprising a first externally threaded end having a male conical tapered surface;
a female component made from the machinable ceramic, the female component comprising a second externally threaded end having a female conical tapered surface;
a B nut made from the machinable ceramic, the B nut comprising interior threads configured to mate with the second externally threaded end of the female component;
a sleeve made from the machinable ceramic and configured to screw onto a threaded portion of the male component;
the B nut configured to slide over the male component such that the sleeve can screw onto the male component, thereby capturing the B nut; and
wherein a portion of the B nut is configured to interact with the sleeve to pull the male conical tapered surface and the female conical tapered surface together upon screwing the B nut onto the female component.

7. The conduit joining system of claim 6, further comprising a seal having an annular shape and comprising a tapered surface that is sized and dimensioned to rest between the male conical tapered surface and the female conical tapered surface.

8. The conduit joining system of claim 7, wherein compressing the seal results in a gas-tight and fluid-tight seal.

9. The conduit joining system of claim 6, wherein the machinable ceramic is electrically insulating and corrosion resistant.

10. The conduit joining system of claim 6, wherein the female conical tapered surface is complementary to the male conical tapered surface.

11. A conduit joining system, comprising:
a male component;
a female component;
a B nut;
a sleeve configured to screw onto a threaded portion of the male component;
the B nut configured to slide over the male component;
the sleeve configured to screw onto the male component upon sliding the B nut over the male component;
the B nut configured to screw onto the female component such that a portion of the B nut interacts with the sleeve to pull the male component and the female components together; and
wherein each of the male component, the female component, the sleeve, and the B nut are made from a non-metal.

12. The conduit joining system of claim 11, wherein the B nut is configured to screw onto the female component such that a portion of the B nut interacts with the sleeve to pull the male component and the female components.

13. The conduit joining system of claim 11, wherein the non-metal comprises a machinable ceramic.

14. The conduit joining system of claim 11, wherein the non-metal comprises a plastic.

15. The conduit joining system of claim 11, wherein the non-metal comprises a polymer.
